(19) United States
(12) Patent Application Publication
(10) Pub. No.: US 2008/0270815 A1
(43) Pub. Date: Oct. 30, 2008

(54) DEVICE CONTROL APPARATUS AND DEVICE CONTROL METHOD

(75) Inventor: Naoki Yamanashi, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/054,172

(22) Filed: Mar. 24, 2008

(30) Foreign Application Priority Data
Apr. 27, 2007 (JP) 2007119799

(51) Int. Cl. G06F 1/32

(52) U.S. Cl. 713/324

(57) ABSTRACT

A device control apparatus includes: an interface connectable to at least one device having a power-saving function of stopping an action of a storage unit when a state that the storage unit is not accessed continues for more than a given time; a test data writing unit transmitting a writing command of test data to the storage unit through the interface in an interval shorter than the given time, when the device is connected to the interface; and a test data deleting unit transmitting to the device a deleting command to delete the test data in correspondence with a reception of a response to the writing command, the response being indicating writing completion and sent back from the device.

### CROSS-REFERENCE TO THE INVENTION

This application is based upon and claims the benefit of priority from the prior Japanese Patent Application No. 2007-119799, filed on Apr. 27, 2007; the entire contents of which are incorporated herein by reference.

### BACKGROUND OF THE INVENTION

1. Field of the Invention

The present invention relates to a device control apparatus and a device control method.

2. Description of the Related Art

There is known a technology to access a device to acquire information such as contents name from a plurality of contents recorded in this device to display a list thereof (for example, see Japanese Patent Application Laid-open No. 2005-216451). This list is used to select contracts to reproduce.

### BRIEF SUMMARY OF THE INVENTION

By the way, in recent years, a great deal of attention is attracted to a device called a NAS (Network Attached Storage), which is compatible for network connection and mounts a hard disk apparatus as a storage unit. The NAS mounts a CPU and an OS therein and meticulous internal control is possible. In many cases, the NAS mounts a power-saving function such as, for example, stopping rotation of the hard disk apparatus after a lapse of given time in order to save power consumption. When the hard disk apparatus compatible for network connection is used as a recording device of a digital television, the following problem occurs. For example, when contents are read or written (in other words, reproduced or recorded) from/to the NAS in a state that the rotation of the hard disk is stopped, it is necessary to cancel a power-saving state of the NAS, to rotate the hard disk and to increase a rotation speed of the hard disk to some degree. In this case, a time lag is generated and writing or reading of the contents may fail.

It is an object of the present invention to provide a device control apparatus capable of surely reproducing or recording contents from/to a device and a device control method therefor.

A device control apparatus according to an embodiment of the present invention includes: an interface connectable to at least one device including a storage unit allowing contents to be read and written therefrom/thereto and having a power-saving function of stopping an action of the storage unit when a state that the storage unit is not accessed continues for more than a given time; a test data writing unit transmitting a writing command of test data to the storage unit through the interface in an interval shorter than the given time; and a test data deleting unit transmitting to the device a deleting command to delete the test data in correspondence with a reception of a response to the writing command, the response being indicating writing completion and sent back from the device.

A contents reproducing method according to an embodiment of the present invention is a device control method in a device control apparatus including an interface connectable to at least one device including a storage unit allowing contents to be read and written therefrom/thereto and having a power-saving function of stopping an action of the storage unit when a state that the storage unit is not accessed continues for more than a given time, the device control method including: transmitting a writing command of test data to the storage unit through the interface in an interval shorter than the given time; and transmitting to the device a deleting command to delete the test data in correspondence with a reception of a response to the writing command, the response being indicating writing completion and sent back from the device.

### BRIEF DESCRIPTION OF THE DRAWINGS

FIG. 1 is a block diagram showing a configuration of a contents reproduction/recording system 1.

FIG. 2 is a schematic diagram showing table data stored in a memory 29.

FIG. 3 is a schematic diagram showing an example of display of a display unit 27.

FIG. 4 is a flowchart showing actions of a reproduction control apparatus 20.

FIG. 5 is a schematic diagram showing table data stored in a memory 29 of a reproduction control apparatus 20 to which two or more devices are connected.

FIG. 6 is a modification example of a reproduction menu displayed on the display unit 27.

### DETAILED DESCRIPTION OF THE INVENTION

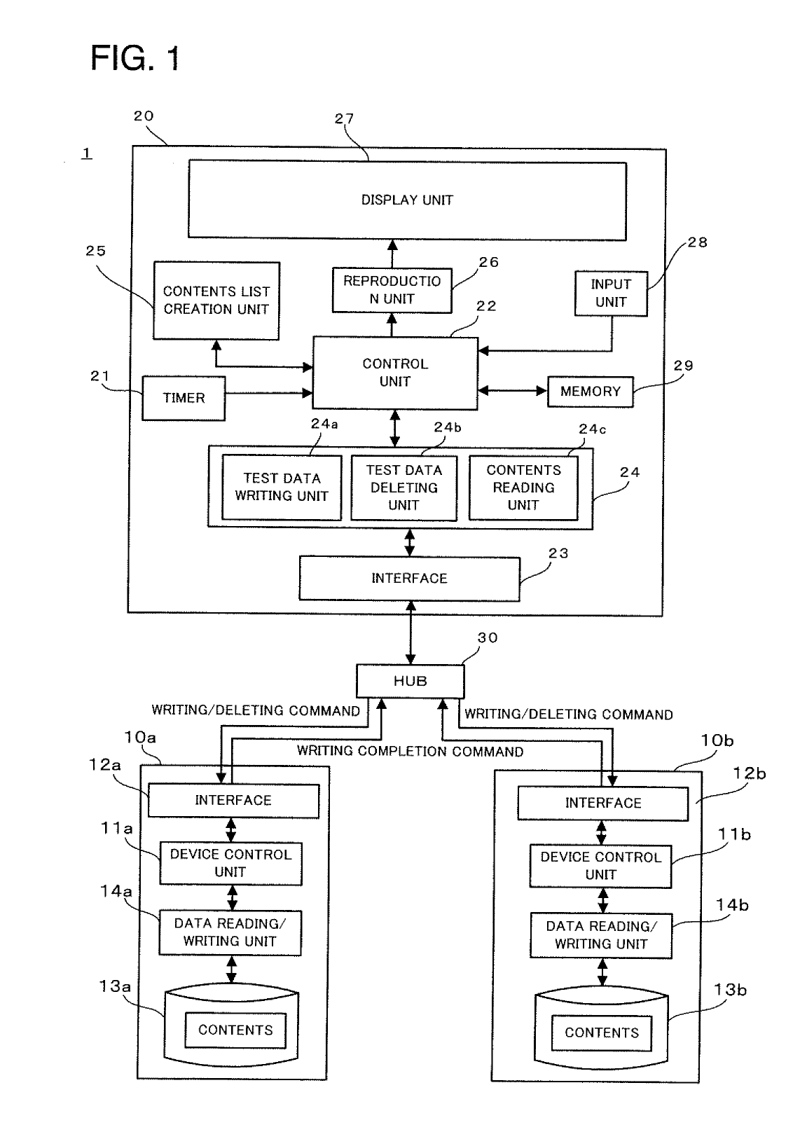

Hereinafter, an embodiment according to an aspect of the present invention will be described in detail with reference to the drawings. FIG. 1 is a block diagram showing a configuration of a contents reproduction/recording system 1 according to one embodiment of the present invention. As shown in FIG. 1, the contents reproduction/recording system 1 is constituted by connecting devices such as devices 10a, 10b, a reproduction control apparatus 20 as a device control apparatus, and a HUB 30 to, for example, a LAN (Local Area Network) or the like. The devices 10a, 10b are, for example, devices called NASs (Network Attached Storages). The NAS is directly connected to a network such as a LAN without via a PC (Personal Computer) and functions as a file server.

The devices 10a, 10b can also be, other than the NASs, devices having storage means storing predetermined information such as PCs, USB (Universal Serial Bus) memories, USB connection-type hard disk drive apparatuses (hereinafter referred to as “HDD”s: Hard Disk Drives). The devices 10a, 10b can also be disk apparatuses performing recording and/or writing of information by rotating disk-shaped storage media. The above disk apparatus is, for example, a CD-ROM drive, a CD-R (CD-RW) drive, a DVD drive, a DVD-R(RW) drive, an HD-DVD drive or the like. The devices 10a, 10b respectively have apparatus control units 11a, 11b, interfaces 12a, 12b, contents storage units 13a, 13b, and data reading/writing units 14a, 14b. The devices 10a, 10b are constituted almost identically. The devices 10a, 10b store contents in hard disks (not shown) being media to store contents, the hard disks being had by the contents storage units 13a, 13b.

The “contents” are, for example, a moving image (data in a form of Mpeg-2 or Mpeg-4) made by compress recording a TV program, or a still image (data in a form of bit map, JPEG, PING, GIF or the like) made by recording an image by a digital camera (not shown) via, for example, a memory card. Further, the “contents” are information such as, for example, music data (MP-3, AAC or the like) downloaded by a music distribution service performed on the Internet, or audio data (WAV data)reproduced from a home CD and converted to a digital signal.

The devices 10a, 10b perform reading/writing of the contents from/to the contents storage unit 13a, 13b by receiving various data including a control command from the reproduction control apparatus 20 via the LAN. The “control command” is, for example, a command to instruct reading/writing of the contents from/to the contents storage units 13a, 13b. The “control command” is also a command, for example, to instruct writing/deleting test data to/from the contents storage unit 13a, 13b.

The “command to instruct reading/writing of the contents” is constituted with, for example, 1 byte of request type, 2 bytes of request data length, 1 byte of location length, 255 bytes at maximum of location, 1 byte of file name length, and 255 bytes at maximum of file name and the like. When receiving this command, the device 10a and/or the device 10b read(s) the contents based on the request type, file name or the like of the instruction command. The “command to instruct writing/deleting of test data” is constituted with, for example, 1 byte of request type, 2 bytes of request data length, 1 byte of location length, 255 bytes at maximum of location, 1 byte of data length, several bytes to several ten kilobytes of test data and the like. The “test data” is data of several bytes to several ten kilobytes (for example, about 16 bytes), and its contents are not particularly limited.

When the control command from the reproduction control apparatus 20 is not received for more than a given time, the devices 10a, 10b stop rotation of the hard disks of the contents storage units 13a, 13b. In the devices 10a, 10b, power saving can be achieved by stopping the rotation of the hard disks (here, a state that the hard disk is rotating is referred to as a “normal state” and a state that the rotation of the hard disk is stopped is referred to as a “power-saving state”). If the devices 10a, 10b are disk devices, stopping the rotation of the disk-shaped storage media leads to the power-saving state.

When receiving a command to read contents in the power saving state, the devices 10a, 10b rotates the hard disks. On this occasion, the hard disk starts to rotate from a state of no rotation, gradually increases a rotation speed, and, when reaching a predetermined speed, keeps rotating with maintaining that speed constant. If reading/writing is performed before the hard disk rotates at the predetermined speed, there may occur a problem that the contents storage units 13a, 13b become in a state of not reacting (freeze) and so on.

If the test data is recorded before the reading/writing of the contents from/to the contents storage units 13a, 13b, the contents storage units 13a, 13b becomes in the normal state and the above problem can be prevented. In other words, the devices 10a, 10b receive from the reproduction control apparatus 20 a command to instruct writing of test data before reading/writing of the contents. As a result, the contents storage units 13a, 13b become in the normal state and the above-described problem can be prevented.

When receiving the test data writing command, the devices 10a, 10b record the test data in predetermined regions of the hard disks, and thereafter, return test data writing completion commands to the reproduction control apparatus 20. The test data writing completion command is constituted with, for example, 2 bytes of total length, 1 byte of request type, 2 bytes of response data length, 1 byte of data length, and 255 bytes at maximum of response result.

The apparatus control units 11a, 11b mainly control the interfaces 12a, 12b and the data reading/writing units 14a, 14b. The apparatus control units 11a, 11b have power saving functions. In other words, if the control commands are not received for a predetermined time (for example, 90 seconds or the like), the apparatus control units 11a, 11b control data reading/writing units 14a, 14b to make the rotation of the hard disks in the content storage units 13a, 13b stop automatically. The apparatus control units 11a, 11b receive the control commands from the reproduction control apparatus 20 via the interfaces 12a, 12b. The apparatus control units 11a, 11b also transmit the test data writing completion commands to the reproduction control apparatus 20 via the interfaces 12a, 12b.

The apparatus control units 11a, 11b control the data reading/writing units 14a, 14b to read write contents from/to the contents storage units 13a, 13b. The interfaces 12a, 12b are one of communication means to connect the devices 10a, 10b and the reproduction control apparatus 20 via the HUB 30, being, for example, LAN interface boards including LAN terminals.

The interfaces 12a, 12b receive various data including the control commands from the reproduction control apparatus 20. The various data received by the interfaces 12a, 12b is distributed to the apparatus control units 11a, 11b.

It should be noted that the interfaces 12a, 12b may have various kinds of terminals such as USB or IEEE 1394 and so on, in addition to the LAN terminals.

The contents storage units 13a, 13b are, for example, HDDs or the like, in which the contents are stored. The HDD has a not-shown hard disk, a motor to rotate this hard disk, a control unit to control rotation of this motor, and the like. The contents storage units 13a, 13b can be disk-shaped storage media such as DVD-Rs.

The reproduction control apparatus 20 is, for example, an apparatus called a digital terrestrial television broadcasting tuner (DTV) and may have or may not have a display unit such as a TFT liquid crystal screen. In this example, the reproduction control apparatus 20 with the display unit will be described. The devices 10a, 10b are connected to the reproduction control apparatus 20 via the HUB 30. It should be noted that there is described here the example in which only two devices 10a, 10b are connected to the reproduction control apparatus 20 for simplicity of description, but the present invention is not limited thereto and three or more devices may be connected.

The reproduction control apparatus 20 controls the connected device 10a and/or device 10b. For example, the reproduction control apparatus 20 controls alteration from the power-saving state to the normal state of the devices 10a, 10b. The reproduction control apparatus 20 also controls reproduction of the contents the devices 10a, 10b store. The reproduction control apparatus 20 is also capable of recording (in other words, video recording) of the contents to the devices 10a, 10b.

Granting of IP addresses to the devices 10a, 10b in accordance with a TCP/IP protocol enables the reproduction control apparatus 20 to separately control the respective devices 10a, 10b. By any apparatus on the LAN having a DHCP function, the IP address can be automatically granted. It should be noted that IP addresses of fixed values can be granted to the devices 10a, 10b. If the reproduction control apparatus 20 has the DHCP function, the reproduction control unit 20 grants an IP address when, for example, the control unit 22 (system) starts up.

An IP address is granted by transmission/reception of various commands called DHCP messages between the reproduction control apparatus 20 and the devices 10a, 10b through, for example, the LAN. One of the “DHCP messages” is, for example, a signal called DHCP DISCOVER (discovery signal). Otherwise, one of the “DHCP messages” is a signal called DHCP OFFER (response signal). “DHCP DISCOVER” is periodically transmitted to the LAN by the devices 10a, 10b or the reproduction control apparatus 20.

“DHCP OFFER” is a signal sent back when the devices 10a, 10b or the reproduction control apparatus 20 receive “DHCP DISCOVER” via the LAN. “DHCP OFFER” includes IP addresses to be granted to the devices 10a, 10b.

The reproduction control apparatus 20 has a timer 21, a control unit 22, an interface 23, an information transmission/reception unit 24, a contents list creation unit 25, a reproduction unit 26, a display unit 27, an input unit 28, and a memory 29. The reproduction control apparatus 20 also has, though not particularly shown, an encoder/decoder corresponding to each format (Mpeg-2 or Mpeg-4) of the contents, a TV tuner, a speaker and the like.

The timer 21 starts keeping time for a predetermined time by an instruction of the control unit 22, and after having kept the predetermined time, the timer 21 notifies the control unit 22 that time is up. After notification of time-up, the timer 21 is reset by the control unit 22. The timer 21 can reset its own count value after the notification of time-up. By resetting, the timer 21 again keeps time for a predetermined time.

The “predetermined times” for which the timer 21 keeps time are an interval time of the test data writing command transmissions and a limit time of a reception time of the test data writing completion command being a response of the devices 10a, 10b to the test data writing command. The “interval time of the test data writing command transmissions” is shorter than a time spent for change from the normal state to the power-saving state of the devices 10a, 10b. For example, if the time spent for the change from the normal state to the power-saving state of the devices 10a, 10b is 90 seconds, the “interval time of test data writing command transmissions” can be set to be 80 seconds or 60 seconds. The “interval time of test data writing command transmissions” can be some ten seconds or shorter. The “limit time of reception time of test data writing completion command” is, for example, 10 seconds or the like. These times are stored in the memory 29 in advance as timekeeping time information.

The control unit 22 controls the timer 21, the interface 23, the information transmission/reception unit 24, the content list creation unit 25, the reproduction unit 26, the input unit 28, and the memory 29 respectively. The control unit 22 reads the timekeeping information from the memory 29 to control the timer 21. The control unit 22 receives a time-up notification notified by the timer 21 having kept time for the predetermined time. The control unit 22 controls the information transmission/reception unit 24 to prevent the device 10a and/or the device 10b from becoming to the power saving state. In other words, the control unit 22 controls the information transmission/reception unit 24 based on the time-up notification of the “interval time of test data writing command transmissions” of the timer 21, and makes the information transmission/reception unit 24 transmit the test data writing command.

The control unit 22 receives the test data writing completion command transmitted from the device 10a and/or the device 10b via the information transmission/reception unit 24, whereby the control unit 22 judges existence/absence of connection thereto. The control unit 22 can judge whether or not a “response result” included in the received test data writing completion command corresponds to the “test data” included in the transmitted test data writing command.

When receiving the test data writing completion command including the “response result” corresponding to the “test data” before receiving the time-up notification of the “time limit of receiving time of test data writing completion command” from the timer 21, the control unit 22 judges the connection to the device 10a and/or the device 10b as “Yes”. The control unit 22 judges the connection to the device as “No” if the control unit 22 does not receive a response before receiving the time-up notification of the “time limit of receiving time of test data writing completion command”.

The control unit 22 stores the existence/absence of the connection to the device 10a and/or device 10b to the memory 29 as connection information. The control unit 22 further controls the information transmission/reception unit 24 and makes the information transmission/reception unit 24 acquire meta-information of the contents the device 10a and/or the device 10b store(s). The meta-information is information showing, for example, a title of the contents, a category, a creator's name, and information showing an address (for example, a device name to which an IP address is allotted and a directory file name in that device) at which a substantive file of the contents exists.

The control unit 22 relates at least one piece of meta-information among the acquired meta-information, information to specify the device 10a and/or the device 10b from which this meta-information is acquired, and connection information of each device stored in the memory 29 in advance, and stores them to the memory 29. For example, a directory file name being meta-information, an IP address to specify the device, and the connection information are related, and stored as table data.

It should be noted that meta-information is not acquired for the device 10a and/or the device 10b whose connection information is “No”. In this case, data indicating a state that meta-information is absent can be stored to the memory 29 as table data.

The control unit 22 outputs a contents list based on the meta-information, the IP address and the connection information which are stored in the memory 29 to the contents list creation unit 25. The control unit 22 receives the contents list from the contents list creation unit 25 and controls the reproduction unit 26 to make the contents list displayed in the display unit 27.

The control unit 22 performs various types of control based on an input signal from the input unit 28. The control unit 22, for example, controls the information transmission/reception unit 24 to make the contents which are selected by the input unit 28 read from the appropriate device of the device 10a and the device 10b. When the contents to be reproduced is selected by a button operation of the input unit 28, the control unit 22 acquires information of a location in which these contents are kept from the contents list creation unit 25 and notifies the information transmission/reception unit 24, whereby the control of reading is performed. The read contents are displayed in the display unit 27 (in other words, the contents are reproduced).

The control unit 22 also functions as a contents selection invalidating unit. In this case, the control unit 22 invalidates selection by the input unit 28 of contents of the device 10a and/or the device 10b for which the connection information is “No”. The interface 23 can have ports of various kinds such as LAN, USB and IEEE 1394, similarly to the interfaces 12a, 12b of the devices 10a, 10b.

The interface 23 can also have terminals of various memory cards such as an SD (Secure Digital) memory card, an MMC (Multimedia Card), a memory card such as a memory stick, and an IC card.

The devices 10a, 10b are connected to the interface 23 via the HUB 30. The interface 23 is used to perform information transmission to/from the devices 10a, 10b.

The information transmission/reception unit 24, which are controlled by the control unit 22, has a test data writing unit 24a, a test data deleting unit 24b, and a contents reading unit 24c.

The test data writing unit 24a transmits a command for the device 10a and/or the device 10b to write test data.

The test data deleting unit 24b receives the test data writing completion command from the device 10a and/or the device 10b. The test data deleting unit 24b transmits a command for the device 10a and/or the device 10b, which have/has transmitted the test data writing completion command, to delete the test data.

The contents reading unit 24c transmits a contents reading command or the like to the device 10a and/or the device 10b. The contents list creation unit 25 creates the contents list by control of the control unit 22.

The reproduction unit 26 functions as a reproduction menu output unit. The reproduction unit 26 makes the display unit 27 display the reproduction menu including the contents list created by the contents list creation unit 25 and the contents read from the devices 10a, 10b.

It is desirable that the control unit 22 continues to transmit the test data writing command to the device 10a or the deice 10b, when the reproduction menu is displayed in the display unit 27.

The display unit 27 is a display device constituted with a liquid crystal panel or the like and displays the contents read from the devices 10a, 10b and/or the reproduction menu.

The input unit 28 is, for example, a touch panel, a press-type button group, a keyboard or the like and is a device for selecting desired contents from the reproduction menu outputted by the reproduction unit 26. The input unit 28 can be a receiving device (for example, an infrared receiving device) which receives a command from a not-shown remote controller mounting a button equivalent to the above.

A user can make the display unit 27 display the reproduction menu by using the input unit 28. The user can select contents desired to reproduce while referring to the reproduction menu displayed in the display unit 27.

In the memory 29 are stored the timekeeping time information of the timer 21, the IP address the control unit 22 has granted to the devices 10a, 10b, and the like.

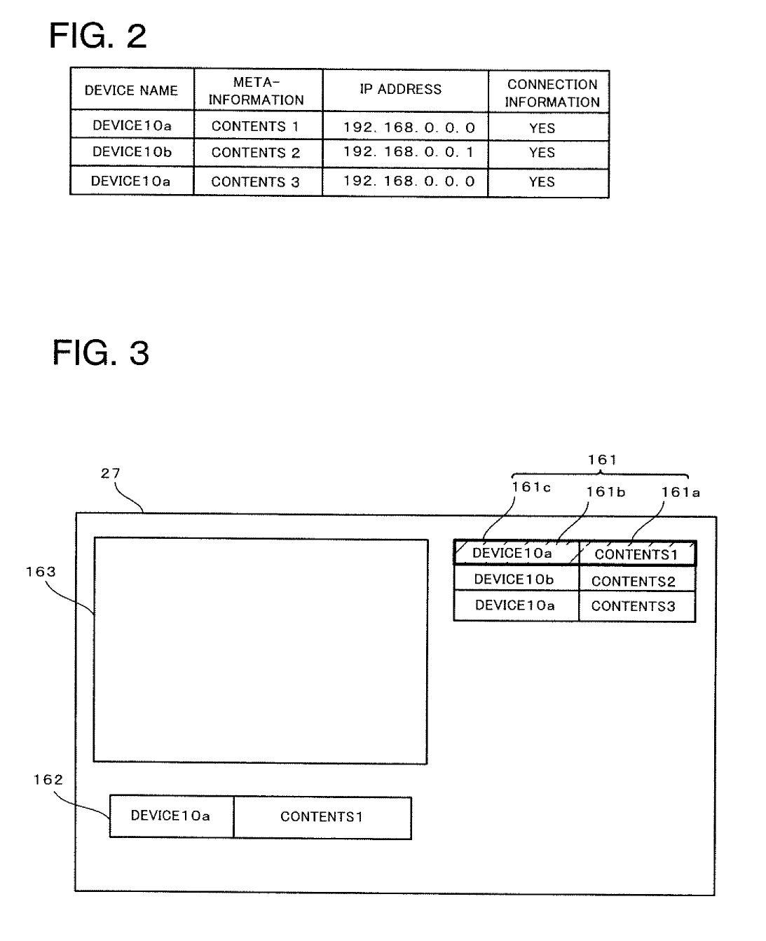

Next, the table data stored in the memory 29 will be described by using FIG. 2. FIG. 2 is a schematic diagram showing table data stored in a memory.

As shown in FIG. 2, a device name, meta-information, an IP address, and device information are stored, with being related to each other, in the memory 29. The “device name” can be allotted by the control unit 22 based on the IP address. The “device name” can also be the one stored in the devices 10a, 10b in advance and acquired via the information transmission/reception unit 24 at a time of IP address allotment. The “meta-information” is information such as a title of contents, a category and a creator, or an address at which a substantive file of the contents exists.

The “IP addresses” are allotted to the devices 10a, 10b by the control unit 22. As a matter of course, different values are allotted to the device 10a and the device 10b. The “connection information” is judgment by the control unit 22 of whether or not the connection to the device 10a and/or 10b exists. When the connection is confirmed, the connection information is indicated as “Yes”. When the connection is not confirmed, the “connection information” is indicated as “No”. The indication of “Yes” and “No” of the “connection information” is rewritten accordingly depending on change of a connection state of the LAN or the like. Change of a connection state means a state that the connection to the device 10a and/or the device 10b cannot be confirmed or the like due to influence of, for example, a noise or the like.

Next, the reproduction menu displayed in the display unit 27 will be described by using FIG. 3. FIG. 3 is a schematic diagram showing an example of display of the display unit 27. As shown in FIG. 3, the display unit 27 has a contents list display screen 161 as the reproduction menu, a selected device information display screen 162, and a preview screen 163.

The contents list display screen 161, the selected device information display screen 162, and the preview screen 163 can be made to perform displaying by a predetermined operation of the input unit 28. The contents list created by the contents list creation unit 25 is displayed on the contents list display screen 161.

The contents list display screen 161 is constituted with a predetermined number of information display columns. These columns have a contents display column 161a and a device name display column 161b. At least one of main data is displayed in the contents display column 161a. For example, a title of contents is displayed in the contents display column 161a. Displaying of the title of the contents in the contents display column 161a enables the user to know details of the contents easily. A device name (for example, “device 10a”, “device 10b”) in which contents displayed in the contents display column 161a is stored is displayed in the device name display column 161b. As a matter of course, the information displayed in the contents display column 161a and the device name display column is not limited to the device name or the title name, but, for example, an IP address or other meta-information can also be displayed.

The contents list display screen 161 further has a pointer 161c. The pointer 161c moves up/down by a button operation of the input unit 28. The contents display column 161a and the device name display column 161b which are selected by the pointer 161c are displayed in a distinguishable manner from other display columns. For example, such a column is distinguished in terms of a reversed character, an outline character, and a background color different from colors of other columns. The device name and the meta-information which are selected by the pointer are displayed in the selected device information display screen 162.

The selection by the pointer 161c and a predetermined operation (for example, an operation such as not-shown “preview reproduction”) by the input unit 28 make the contents be displayed in the preview screen 163. It is also possible to make the preview screen 163 display the contents displayed in the contents display column 161a selected by the pointer 161c even without the operation of the input unit 28. The display in the preview screen 163 is performed by reading of the contents from the device 10a or the device 10b by the control unit 22 based on the IP address and meta-information of the device 10a or the device 10b corresponding to the device name or the contents name selected by the pointer 161c.

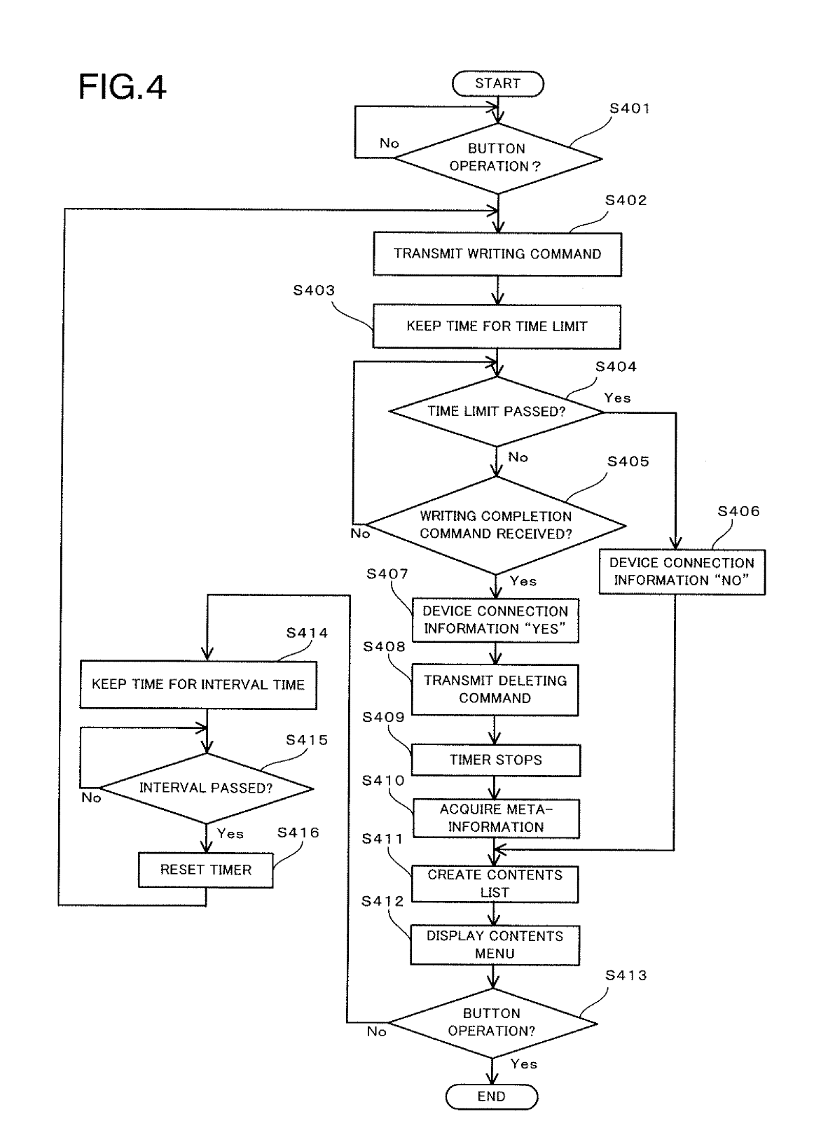

Next, actions of the reproduction control apparatus 20 will be described by using FIG. 4. FIG. 4 is a flowchart showing the actions of the reproduction control apparatus 20. It should be noted that the following actions are performed in a state that the IP addresses are granted to the devices 10a, 10b in advance.

First, the user performs switching to a mode in which the reproduction menu is displayed in the display unit 27 (step S401 in FIG. 4) by an operation of the input unit 28. On this occasion, the control unit 22 of the reproduction control apparatus 20 controls the test data writing unit 24a to transmit the test data writing command to the devices 10a, 10b (S402).

Subsequently, the control unit 22 controls the timer 21 to keep time for the time limit of the reception time of the test data writing completion command (step S403).

The control unit 22 is in a standby state until receiving the time-up notification from the timer 21, or receiving the test data writing completion command from the devices 10a, 10b (step S404, step S405).

In the step S404, if the control unit 22 receives the time-up notification from the timer 21 before receiving the test data writing completion command from the device 10a and/or the device 10b, the control unit 22 judges that the device 10a and/or the device 10b are (is) not connected.

On this occasion, the control unit 22 sets the connection information for the device 10a and/or the device 10b as “No” (step S406).

In the step S405, if the control unit 22 receives the test data writing completion command(s) from the device 10a and/or the device 10b, the control unit 22 sets the connection information for the device 10a and/or the device 10b as “Yes” (step S407).

Next, the control unit 22 controls the information transmission/reception unit 24 to transmit (a) test data deleting instruction command(s) to the device 10a and/or the device 10b whose connection information is judged as “Yes” (step S408).

Then, the control unit 22 controls the timer 21 to stop keeping time for the time limit of the reception of the test data writing completion command (step S409).

Further, the control unit 22 controls the information transmission/reception unit 24 to acquire the meta-information of the contents stored by the device 10a and/or the device 10b the connection information of which is “Yes” (step S410).

It suffices that the meta-information acquisition at the step S410 is performed once, and there is no need for subsequent acquisition.

Next, the control unit 22 controls the contents list creation unit 25 to create the contents list (step S411). Thereafter, the control unit 22 controls the reproduction unit 26 to make the display unit 27 display the reproduction menu including the contents list.

Subsequently, the control unit 22 becomes in awaiting state for an input from the input unit 28 (step S413). The “input” in the “waiting state for input” means, for example, the user's performing an operation of terminating a mode in which the reproduction menu is displayed, by using the input unit 28.

If the input from the input unit 28 does not occur while waiting, the control unit 22 controls the timer 21 to start keeping time for the interval time of test data writing command transmissions (step S414).

Next, the control unit 22 judges whether or not timekeeping, by the timer 21, of the interval time between the test data writing command transmissions reaches a predetermined time (step S415). This judgment is performed by whether or not the time-up notification is received from the timer 21.

In the step S415, on receiving the time-up from the timer 21, the control unit 22 resets a timekeeping action of the timer 21 (step S416). Then, the control unit 22 controls the information transmission/reception unit 24 to repeat a series of processings from the step S402, that is, transmitting the test data writing commands to the devices 10a, 10b.

When a predetermined operation (for example, turning off a power source, termination of a reproduction menu display mode) of the input unit 28 is performed, the series of actions ends.

As stated above, according to the contents reproduction/recording system 1 of this embodiment, the test data writing commands are transmitted to the connected device 10a and/or device 10b at every predetermined time. As a result, the device 10a and/or device 10b do (does) not become in the standby state, and it can be prevented that stop of disk rotation consumes time to read the contents.

Since the connection condition of the devices 10a, 10b is judged by the existence/absence of the reception of the test data writing completion command, which is to respond to the test data writing command transmission, and, for the unconnected device, a selecting operation by the input unit 28 is not accepted. Therefore, writing to the unconnected device is not performed. Accordingly, a transmission of a reproduction request or the like to an unconnected device can be omitted, and it is possible to prevent unnecessary time consumption.

### Other Embodiments

The embodiment of the present invention is not limited to the above embodiment but can be extended or modified. An extended or modified embodiment is included in the technical range of the invention.

Though the example of a LAN standard network is described in the above-described embodiment, the network system is not limited thereto and the present invention is applicable also to various types of network transmitting digital data such as a wireless LAN, an IEEE 1394, a telephone line, an electric light line, and a wireless.

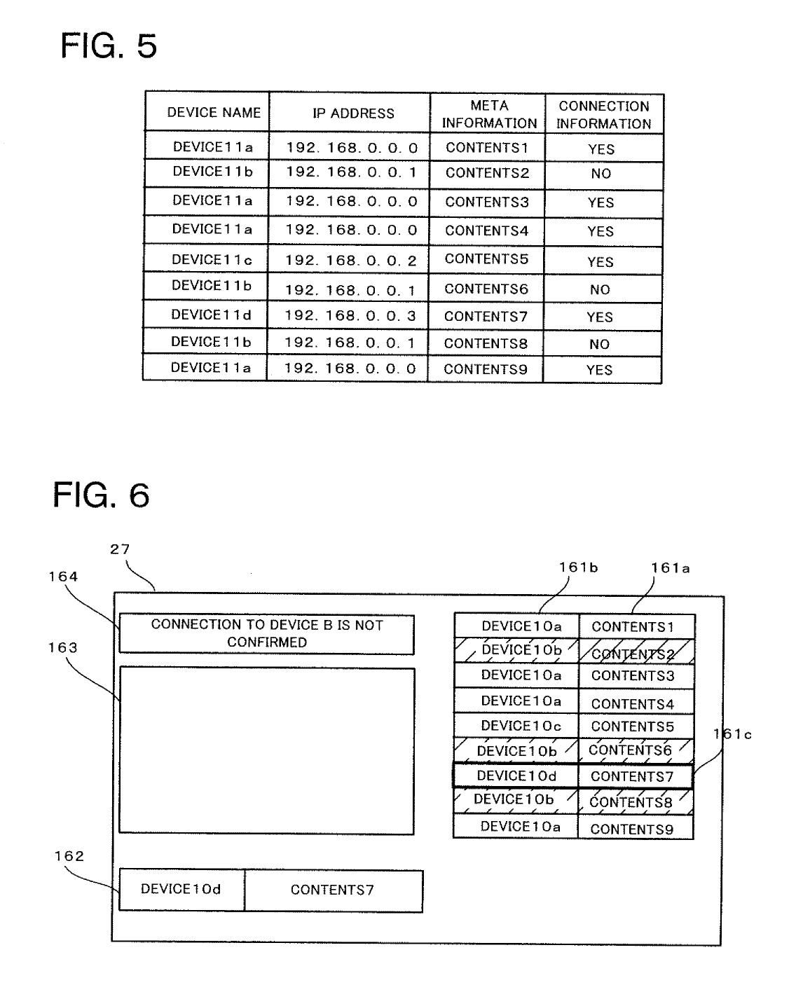

Hereinabove, the example is described in which two devices 10a, 10b are connected to the reproduction control apparatus 20. However, the number of the devices to be connected to the reproduction control apparatus 20 is not limited thereto but still more devices can be connected. A modification example of table data and a display unit 27 of a memory 29 in such a case will be described by using FIG. 5 and FIG. 6.

Here, assume that four devices 10a, 10b, 11c, 11d are connected to a reproduction control apparatus 20. In the following description, it is assumed that, by a control unit 22, the devices 10a, 11c, 11d are judged to be connected, and the device 10b, with no response to a test data writing command therefrom, is judged to be unconnected.

In this case, however, connection of the device 10b has been recognized as “Yes” at a system startup time of the reproduction control apparatus 20 but is recognized as “No” at a time to check connection of the devices 10a, 10b, 11c, 11d in a reproduction menu display mode.

Since various actions performed to these devices 10a, 10b, 11c, 11d, such as a test data writing command transmission, are similar to the procedure shown in FIG. 4, detailed description will be omitted.

Existence/absence of recognition of the connection of the devices 10a, 11c, 11d may change due to influence of a noise or the like.

Here, in the table data stored in the memory 29 by the control unit 22, as shown in FIG. 5, connection information of the devices 10a, 11c, 11d is indicated as “Yes” while connection information of the device 10b is indicated as “No”. A menu in this case is shown in FIG. 6. A contents display column 161a and a device name display column 161b to which the unconnected “device 10b” corresponds are gray-displayed and selection by a pointer 161c is impossible.

It is a matter of course that gray display is cancelled when there is a response from the device 10b to a writing command of the test data performed at every predetermined time and the selection by the pointer 161c becomes possible. Other than to gray-display the contents display column 161a and the device name display column 161b, it is also possible to delete the device 10b from the contents list. The gray-display or deleting can be performed by the control unit 22 controlling a contents list creation unit 25 to delete a part corresponding to the device 10b from the contents list. Other than the above, it is also possible that the control unit 22 controls the reproduction unit 26 not to display the part.

The display unit 27 further includes an error display screen 164. It is possible to display “device 10a is not connected” or the like in the error display screen 164. Error display in the error display screen 164 can also be “contents 2, 6, 8 cannot be reproduced”. When the connection information of the device 10b changes from “No” to “Yes”, it is possible to display “device 10b is connected” in the error display screen 164. As a matter of course, the error display in this case is performed by the control unit 22 controlling the reproduction unit 26. In a conventional device control apparatus, there also exist cases that display indicating that contents cannot be reproduced is performed.

In this instance, it is often a case that a reading command of contents is transmitted to a device whose connection state is indicated as “No” and whether or not the contents can be reproduced is judged by whether or not a command responding thereto is done within a predetermined time limit. However, in a contents reproduction recording system 1 of the present invention, since the transmission of the reading command is not performed to the device whose connection state is indicated as “No”, there is no need to wait for a responding command to a reading command of the contents. In other words, time for waiting for the responding command can be saved. Additionally, since the connection state of the device is checked at every given time and can be reflected on the reproduction menu, so that it is possible to save the trouble of checking existence/absence of connection by a user.

It should be noted that in the reproduction control apparatus 20 of the present invention, the contents may be reproduced in full screen in the display unit 27 by an operation of an input unit 28. In such a case, reproduction menu display is not performed and the user sequentially views the next contents or the previous contents of the contents being reproduced by a predetermined operation (for example, a button operation of “next contents”, “previous contents” or the like) of the input unit 28. An order for the viewing of the contents is an order in the contents list created by the contents list creation unit 25.

On the assumption that the above operation is performed, it is desirable, in a case that the contents are reproduced in full-screen in the display unit 27, that writing of test data is performed (in other words, a series of processings from the step S402 shown in FIG. 4 are performed) at least for a device storing the next contents or the previous contents to the contents being reproduced in the display unit 27 (in other words, a series of processings from the step S402 shown in FIG. 4 is performed). Hereby, time can be saved for reading the contents in a case that the device storing the next or previous contents is in a power-saving state. Further, problems such that a device freezes can be prevented.

Of course, it is most desirable to perform writing of the test data for all the devices while the contents are reproduced.

What is claimed is:

1. A device control apparatus, comprising:
an interface connectable to at least one device including a storage unit allowing contents to be read and written therefrom/thereto and having a power-saving function of stopping an action of the storage unit when a state that the storage unit is not accessed continues for more than a given time;
a test data writing unit transmitting a writing command of test data to the storage unit through the interface in an interval shorter than the given time; and
a test data deleting unit transmitting to the device a deleting command to delete the test data in correspondence with a reception of a response to the writing command, the response being indicating writing completion and sent back from the device.

2. The device control apparatus according to claim 1, comprising:
a contents list creation unit acquiring information of contents stored in the storage unit of the device and creating a list of the reproducible contents per the device;
a reproduction menu output unit outputting the reproduction menu including the contents list created by the contents list creation unit; and
a contents selection invalidating unit invalidating selection of the contents of the appropriate device among the contents list outputted by the reproduction menu output unit, when the response is not received.

3. The device control apparatus according to claim 1, further comprising:
an input unit to select desired contents from the reproduction menu outputted by the reproduction menu output unit; and
a reading unit reading the contents selected by the input unit from the device.

4. The device control apparatus according to claim 1, further comprising
a display unit displaying at least the contents read from the device or the reproduction menu.

5. A device control method in a device control apparatus comprising an interface connectable to at least one device including a storage unit allowing contents to be read and written therefrom/thereto and having a power-saving function of stopping an action of the storage unit when a state that the storage unit is not accessed continues for more than a given time, the device control method comprising:
transmitting a writing command of test data to the storage unit through the interface in an interval shorter than the given time; and
transmitting to the device a deleting command to delete the test data in correspondence with a reception of a response to the writing command, the response being indicating writing completion and sent back from the device.

6. The device control method according to claim 5, further comprising:
acquiring information of the contents stored in the storage unit of the device and creating a list of the reproducible contents per the device;
outputting a reproduction menu including the created contents menu; and
invalidating selection of the contents of the appropriate device among the outputted contents list, when the response is not received.

7. The device control method according to claim 5, further comprising:
selecting desired contents from the outputted reproduction menu; and
reading the selected contents from the device.

8. The device control method according to claim 5, further comprising:
displaying the contents read from the device or the reproduction menu.
